(19) United States
(12) Patent Application Publication
(10) Pub. No.: US 2016/0289975 A1
(43) Pub. Date: Oct. 6, 2016

(54) BUILDING BOARD AND METHOD FOR MANUFACTURING THE SAME

(71) Applicant: NICHIHA CORPORATION, Nagoya-shi (JP)

(72) Inventors: Eijiro KOBAYASHI, Nagoya-shi (JP); Koji SAWADA, Nagoya-shi (JP)

(73) Assignee: NICHIHA CORPORATION, Nagoya-shi (JP)

(21) Appl. No.: 15/085,686

(22) Filed: Mar. 30, 2016

(30) Foreign Application Priority Data
Mar. 31, 2015 (JP) 2015-074161

(51) Int. Cl. E04F 13/076; B05D 3/00; E04F 15/02

(52) U.S. Cl. CPC E04F 13/076; E04F 15/02038; B05D 3/007

(57) ABSTRACT

A building board with an appearance being three-dimensional and having a texture of processed lumber and a method for manufacturing the same are provided. A building board includes a base material board, a patterned region formed on the base material board and demarcated by a first joint-like groove and a second joint-like groove intersecting the first joint-like groove, a plurality of wood grain forming protrusions that are formed in the patterned region so as to express a wood grain pattern, an intersecting recess that is formed in the patterned region to have a strip shape extending in a direction intersecting the plurality of wood grain forming protrusions, a first coating formed on the wood grain forming protrusions, and a second coating formed on the intersecting recess, the second coating having a lower lightness than the first coating.

### CROSS REFERENCES TO RELATED APPLICATIONS

This application is based on Japanese Patent Application No. 2015-74161 filed in the Japanese Patent Office on Mar. 31, 2015, the entire contents of which are hereby incorporated by reference.

### BACKGROUND OF THE INVENTION

1. Field of the Invention

The present invention relates to a building board constituting an exterior wall, an interior wall, or the like of a building and a method for manufacturing the same.

2. Description of the Related Art

Conventionally, construction of exterior walls, interior walls, and the like of buildings by installing a plurality of building boards to a structural building frame of a building has been performed. Installation of building boards having an appearance of a wood grain textured design, such as that disclosed in JP 2004-353299A, has also been conventionally performed.

### SUMMARY OF THE INVENTION

However, in recent years, the demand for superior designs of the appearance of building boards has been growing, and with regard to building boards having wood grain textured appearances as well, those having a more three-dimensional appearance and a better texture of processed lumber are required.

An object of the present invention is to provide a building board having an appearance that is three-dimensional and that has a texture of processed lumber as well as a method for manufacturing the building board.

A building board includes:

a base material board;

a patterned region formed on the base material board and demarcated by a first joint-like groove and a second joint-like groove intersecting the first joint-like groove;

a plurality of wood grain forming protrusions formed in the patterned region so as to express a wood grain pattern;

an intersecting recess formed in the patterned region to have a strip shape extending in a direction intersecting the wood grain pattern;

a first coating formed on the wood grain forming protrusions; and

a second coating formed on the intersecting recess, the second coating having a lower lightness than the first coating.

According to the present invention, it is possible to provide a building board having a three-dimensional appearance and a texture of processed lumber.

### DESCRIPTION OF THE PREFERRED EMBODIMENTS

A building board according to a first aspect of the present invention provides a building board in which a first coating and a second coating are formed on a surface of a base material board having a plurality of wood grain forming protrusions for exhibiting a wood grain texture.

A plurality of intersecting recesses extending in a vertical direction are formed on the surface of the base material board. The wood grain forming protrusions extend in a left-right direction, and the intersecting recesses each have an elongated shape and extend in the vertical direction in such a manner as to divide the wood grain forming protrusions in the left-right direction.

The first coating is formed on the wood grain forming protrusions, the second coating is formed on the intersecting recesses, and the first coating has a higher lightness than the second coating. These features allow the building board of the present aspect to have a three-dimensional appearance.

According to a second aspect, at least one of left and right end portions of each of the intersecting recesses has a serrated shape, and at least one of corresponding left and right end portions of the second coating has a serrated shape. This configuration advantageously enables the building board to give the presence and impression of being manually processed lumber.

According to a third aspect, it is preferable that at least one of the left and right end portions of each of the intersecting recesses has a straight line shape, and at least one of the corresponding left and right end portions of the second coating has a straight line shape accordingly.

According to a fourth aspect, each of the intersecting recesses may be continuous in the vertical direction or may be discontinuous in the vertical direction.

According to the foregoing aspects, the width of the second coating formed on each intersecting recess with respect to the left-right direction may be uniform or may be nonuniform.

According to the foregoing aspects, the second coating may be formed under the first coating, or the first coating may be formed under the second coating.

Furthermore, an aspect of the present invention provides a method for manufacturing a building board, by which a first coating and a second coating are formed on a surface of a base material board having a plurality of wood grain forming protrusions for exhibiting a wood grain texture.

The manufacturing method has two aspects.

The aspect of a first manufacturing method has a step of applying a first paint for forming the first coating to the surface of the base material board and drying the first paint, a step of applying a second paint for forming the second coating, and a step of wiping off a portion of the second paint before the second paint cures.

A plurality of intersecting recesses extending in the vertical direction are formed on the base material board. The wood grain forming protrusions extend in the left-right direction, and the intersecting recesses each have an elongated shape and extend vertically in such a manner as to divide the wood grain forming protrusions in the left-right direction. Moreover, the first paint has a higher lightness than the second paint.

According to the first manufacturing method, the first coating is formed under the second coating.

The aspect of a second manufacturing method has a step of applying a second paint for forming the second coating to the surface of the base material board and drying the second paint, and a step of applying a first paint for forming the first coating to the wood grain forming protrusions by pressing a coating roll against the wood grain forming protrusions, and drying the first paint.

A plurality of intersecting recesses extending in the vertical direction are formed on the base material board. The wood grain forming protrusions extend in the left-right direction, and the intersecting recesses each have an elongated shape and extend vertically in such a manner as to divide the wood grain forming protrusions in the left-right direction. Moreover, the first paint has a higher lightness than the second paint.

According to the second manufacturing method, the second coating is formed under the first coating.

In the aspects of the first and second manufacturing methods, it is preferable that at least one end portion (one side) of left and right end portions of each of the intersecting recesses formed on the base material board has a serrated shape.

Meanwhile, it is preferable if at least one end portion (one side) of the left and right end portions of each of the intersecting recesses formed on the base material board has a straight line shape, because an end portion of an adjacent wood grain forming protrusion then becomes more prominent, and a more three-dimensional appearance can be exhibited.

Furthermore, each of the intersecting recesses on the base material board may be continuous in the vertical direction, or may be discontinuous in the vertical direction.

Furthermore, the width of each of the intersecting recesses on the base material board with respect to the left-right direction may be uniform or may be nonuniform.

### BRIEF DESCRIPTION OF THE DRAWINGS

FIG. 1A is a front view of a building board according to a first example of an embodiment of the present invention.

FIG. 1B is an enlarged view of a portion 1B in FIG. 1A subjected to image processing.

FIG. 2 is a front view of a building board according to a second example.

FIG. 3 is front view of a building board according to a third example.

FIG. 4 is a front view of a building board according to a fourth example.

An embodiment of the present invention will be specifically described.

A building board of the present embodiment includes a base material board as well as a first coating and a second coating that are formed on a surface of the base material board.

The base material board is a plate-like member. Examples of the material for the base material board include ceramic siding boards, such as a wood fiber reinforced cement board, a fiber reinforced cement board, a fiber reinforced cement/calcium silicate board, and a slag plaster board, metal siding boards, ALC (Autoclaved Lightweight Aerated Concrete) boards, and the like.

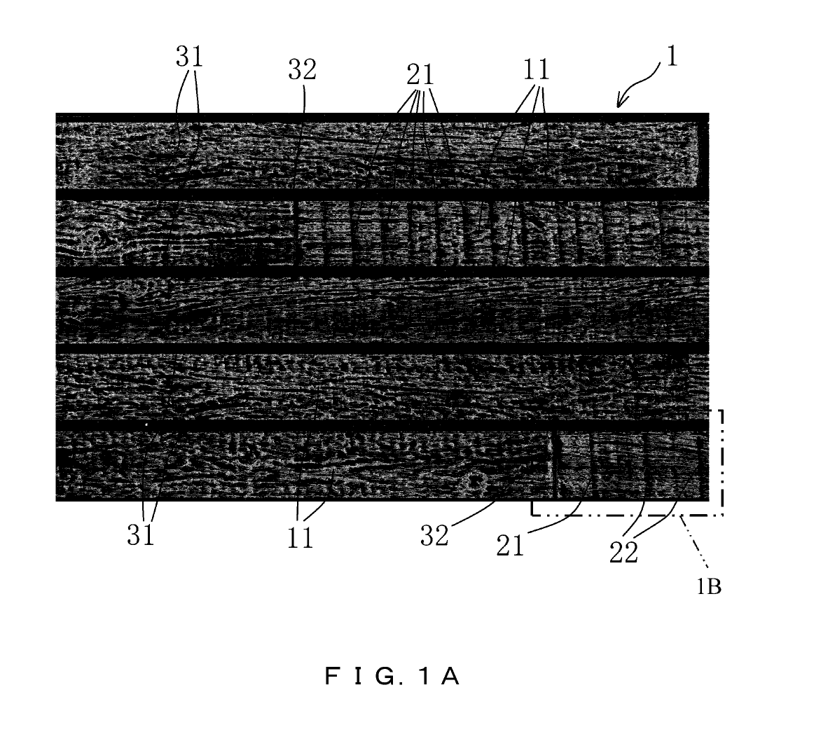

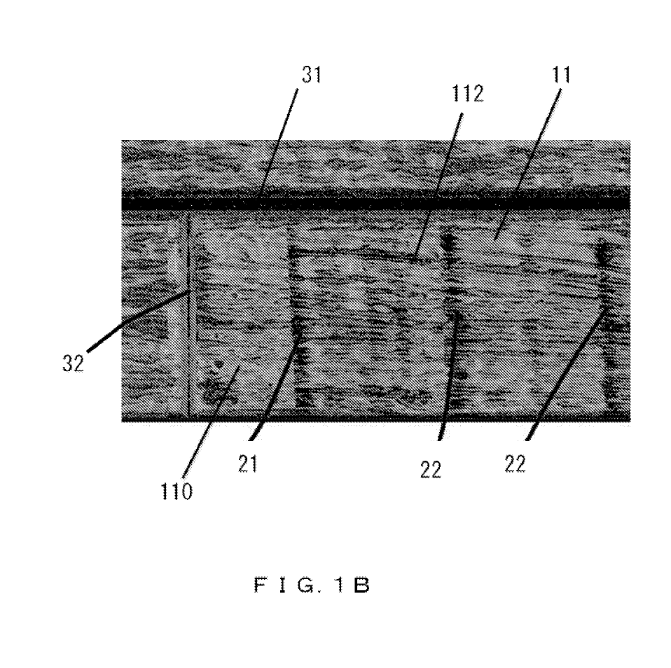

There is no particular limitation on the base material board as long as the base material board is a plate material having a rectangular shape, a square shape, or the like. In the case of the present embodiment, the base material board is a plate material having a rectangular shape, and for the convenience of description, a longitudinal direction of the base material board is referred to as “left-right direction”, and a direction that is orthogonal to the longitudinal direction is referred to as “vertical direction” (see FIG. 1A).

A first joint groove extending in the left-right direction and a second joint groove extending in the vertical direction are formed on the base material board, and a wood grain shape is formed in a rectangular, patterned region demarcated by these two types of joint grooves.

Usually, the base material board has a plurality of patterned regions demarcated by a plurality of first joint grooves and a plurality of second joint grooves. However, in the case where the base material board has only a single patterned region, a pair of opposite sides of the base material board with respect to the left-right direction constitute a pair of first joint grooves, and a pair of opposite sides of the base material board with respect to the vertical direction constitute a pair of second joint grooves.

An uneven shape for expressing a wood grain texture is formed in the patterned region on the surface of the base material board. More specifically, wood grain forming protrusions and wood grain forming recesses, which are portions lower than the wood grain forming protrusions, are formed. In the present embodiment, a plurality of intersecting recesses are further formed, the intersecting recesses extending across a wood grain pattern formed by the wood grain forming protrusions and the wood grain forming recesses. The wood grain forming protrusions, the wood grain forming recesses, and the intersecting recesses can be formed by press-molding the base material board, by cutting the base material board, or by using other methods.

The uneven shape for expressing a wood grain texture refers to, for example, an exaggerated expression of growth rings, cracks, knots, and the like of wood, and protrusions thereof constitute the wood grain forming protrusions. The wood grain forming protrusions are formed extending in the left-right direction of the base material board, no matter what shape the wood grain forming protrusions have. Moreover, in order to express a wood grain, wood grain forming protrusions having various heights are formed, and thus wood grain forming recesses having different depths are formed.

The intersecting recesses can each have any shape as long as it is an elongated groove shape, and examples of the elongated groove shape include a straight line shape, an oblique line shape, and a circular arc shape. All of the intersecting recesses extend in the vertical direction in such a manner as to divide the wood grain pattern, that is, the wood grain forming protrusions in the left-right direction. It should be noted that in the vertical direction, the intersecting recesses may be continuous intersecting recesses that are formed by continuous recesses, or may be discontinuous intersecting recesses that are formed by discontinuous recesses. If the intersecting recesses are discontinuous intersecting recesses, a texture and a feel similar to those of lumber that has been manually cut can be expressed.

Examples of the cross-sectional shape of the intersecting recesses when viewed in the left-right direction include, but not limited to, a V-shape, a rectangular shape, and a circular arc shape.

Moreover, left and right end portions of each of the intersecting recesses may have a serrated shape or a straight line shape. More specifically, one of the end portions of the intersecting recess may have a serrated shape and the other a straight line shape. Furthermore, both end portions may have a serrated shape. A serrated shape refers to a pattern having closely spaced notches like those after severing with a saw, that is, a so-called jagged shape.

Although the intersecting recesses may have a uniform width in the left-right direction, the intersecting recesses may also have an irregularly changing width and can thus have various shapes.

It should be noted that in the case of the present embodiment, in order to make the wood grain forming protrusions prominent, the intersecting recesses are formed such that the depths of the intersecting recesses are, for the most part, shallower than the depths (wood grain forming recesses) of the wood grain pattern formed by the wood grain forming protrusions.

The first coating is formed on the wood grain forming protrusions. The first coating is formed so as to be continuous in the left-right direction along the wood grain forming protrusions.

Meanwhile, the second coating is formed on the intersecting recesses. The second coating is formed along the intersecting recesses and has the appearance of dividing the first coating.

On the wood grain forming protrusions, it is sufficient if the first coating is exposed to the surface of the building board continuously in the left-right direction, and the second coating may be formed or not formed under the first coating.

On the intersecting recesses, it is sufficient if the second coating is exposed to the surface of the building board along the intersecting recesses, and the first coating may be formed or not formed under the second coating.

It should be noted that the shape of the exposed second coating depends on the shape of the intersecting recesses. More specifically, in the case where one of the left and right end portions of an intersecting recess has a serrated shape and the other a straight line shape, one of left and right end portions of the second coating corresponding to the end portion of the intersecting recess having the serrated shape has a serrated shape, and the other end portion of the second coating corresponding to the other end portion of the intersecting recess having the straight line shape has a straight line shape. In the case where both of the left and right end portions of an intersecting recess have a serrated shape, both of the corresponding left and right end portions of the second coating have a serrated shape.

The lightness of the first coating is higher than the lightness of the second coating. Accordingly, the first coating on the wood grain forming protrusions is conspicuous, and the second coating on the intersecting recesses provides shadings.

The first coating and the second coating individually contain a synthetic resin, such as an acrylic resin, a silicone resin, a fluororesin, a silicon acrylic resin, a polyurethane resin, or an epoxy resin, as a main component. A highly weather-resistant resin such as a cyclohexamethacrylate resin or a silicon acrylic resin is preferable because it provides superior weather resistance when used as the main component. It should be noted that since the base material board may have minute pores in its surface, it is preferable that the first coating and the second coating individually contain a filler such as calcium carbonate, clay, or acrylic beads because the filler fills in the pores of the base material board, thereby preventing water absorption from the surface of the base material board. It is preferable that the first coating and the second coating individually contain resin beads, a light stabilizer, and an ultraviolet absorber because these components allow the resulting coatings to have cushioning characteristics, and also to suppress ultraviolet degradation and light degradation.

In the present embodiment, the building board is manufactured in either of two manufacturing methods.

A first manufacturing method has a first-paint application step of applying a first paint for forming the first coating to the surface of the base material board and drying the first paint, a second-paint application step of applying a second paint for forming the second coating onto the first coating, and a second-paint wiping-off step of wiping off the second paint before the second paint cures. Here, the wiping includes scraping.

An uneven shape for expressing a wood grain texture has been formed on the surface of the base material board in advance. More specifically, a plurality of wood grain forming protrusions, a plurality of wood grain forming recesses, and a plurality of intersecting recesses extending in the vertical direction while dividing the wood grain forming protrusions and recesses have been formed. The wood grain forming protrusions, the wood grain forming recesses, and the intersecting recesses are as described above.

In the first-paint application step, while the base material board is conveyed in the left-right direction, the first paint is applied to the entire surface of the base material board. A paint having a higher lightness than the second paint is used as the first paint. With regard to the method for application, a common painting means such as spraying or flow coating may be used. With regard to the method for drying, drying at an ordinary temperature, drying under heating using a drier or the like, or other methods may be performed.

In the second-paint application step, while the base material board on which the first coating has been formed is conveyed in the left-right direction, the second paint is applied to the entire surface of the base material board. With regard to the method for application, a common painting means such as spraying or flow coating may be used.

The second-paint wiping-off step is performed by bringing a wiping member such as a roll into contact with the surface of the base material board while conveying the base material board to which the second paint has been applied in the left-right direction. Since the wood grain forming protrusions and recesses and the intersecting recesses are formed on the surface of the base material board, when the wiping member is brought into contact with the surface of the base material board, the second paint that has been applied to the wood grain forming protrusions is wiped off, and thus the first coating is exposed. On the other hand, the second paint on the intersecting recesses and the wood grain forming recesses is unlikely to be wiped off, and thus the second coating remains thereon and is thus exposed. Therefore, with the first manufacturing method, the first coating is formed under the second coating.

It should be noted that preferably the wiping member is arranged perpendicular to the conveyance direction of the base material board. This arrangement allows the paint to be wiped off in the left-right direction, thereby introducing variations in the coating thickness with respect to the left-right direction. Thus, the resulting base material board has a variety of tones of color in the left-right direction and therefore looks more three-dimensional. Also, the left and right end portions of each intersecting recess become prominent, making the resulting base material board look more three-dimensional. Moreover, the second paint that has been applied to the wood grain forming protrusions can be smoothly wiped off.

A second manufacturing method has a second-paint application step of applying the second paint for forming the second coating to the surface of the base material board and drying the second paint, and a first-paint application step of applying the first paint for forming the first coating onto the second coating of the wood grain forming protrusions by pressing a coating roll against the wood grain forming protrusions, and drying the first paint.

A plurality of wood grain forming protrusions and a plurality of wood grain forming recesses for expressing a wood grain texture as well as a plurality of intersecting recesses extending in the vertical direction have been formed on the surface of the base material board in advance. The wood grain forming protrusions, the wood grain forming recesses, and the intersecting recesses are as described above.

First, the second-paint application step is performed. That is to say, while the base material board is conveyed in the left-right direction, the second paint is applied to the entire surface of the base material board. A paint having a lower lightness than the first paint is used as the second paint.

Next, the first-paint application step is performed. That is to say, while the base material board on which the second coating has been formed is conveyed in the left-right direction, the coating roll is pressed against the wood grain forming protrusions. Since the wood grain forming protrusions are formed on the surface of the base material board, when the coating roll is brought into contact with the wood grain forming protrusions, the first paint is transferred onto the wood grain forming protrusions, forming the first coating on the wood grain forming protrusions. On the other hand, the first paint is unlikely to be transferred onto the intersecting recesses, and thus the second coating is exposed. Therefore, with the second manufacturing method, the second coating is formed under the first coating.

It should be noted that preferably the coating roll is arranged perpendicular to the conveyance direction of the base material board. This arrangement allows the transfer of the paint to be performed in the left-right direction, thereby introducing variations in the coating thickness with respect to the left-right direction. Thus, the resulting base material board has a variety of tones of color in the left-right direction and looks more three-dimensional. Also, the first paint can be smoothly transferred onto the wood grain forming protrusions.

With respect to both of the first and second manufacturing methods, since the wood grain forming protrusions extend in the left-right direction as described above, the first coating is formed extending in the left-right direction.

On the other hand, since the intersecting recesses extend in the vertical direction in such a manner as to divide the individual wood grain forming protrusions in the left-right direction, the second coating extends in the vertical direction in such a manner as to divide the first coating in the left-right direction.

Since the first paint has a higher lightness than the second paint, the lightness of the first coating is higher than the lightness of the second coating. Accordingly, the first coating on the wood grain forming protrusions is conspicuous, and the second coating provides shadings. The second coating is formed in the vertical direction along the intersecting recesses, and the intersecting recesses each have an elongated strip shape. Thus, accented with the second coating, the shape of the first coating (shape of the wood grain forming protrusions) becomes more prominent.

Moreover, with respect to both of the first and second manufacturing methods, the shape of the second coating reflects the shape of the intersecting recesses.

In the case where a base material board in which right end portions of the individual intersecting recesses have a serrated shape is used, corresponding right end portions of the second coating also have a serrated shape, and thus the wood grain forming protrusions are advantageously accented with a serrated pattern. Similarly, left end portions of the individual intersecting recesses may also have a serrated pattern. In the case where both of the left and right end portions of the individual intersecting recesses have a serrated shape, the corresponding left and right end portions of the second coating also have a serrated shape.

In addition to the serrated pattern, in the case where the right end portions of the individual intersecting recesses have a straight line shape, the corresponding right end portions of the second coating also have a straight line shape, and end portions of the wood grain forming protrusions that are adjacent to those right end portions advantageously become prominent.

In the case where an intersecting recess has a substantially uniform width in the left-right direction, the corresponding width of the second coating in the left-right direction is also substantially uniform. In the case where an intersecting recess has an irregular width in the left-right direction, the corresponding width of the second coating in the left-right direction also is irregular, and thus presence and feel similar to those of lumber that has been manually processed are advantageously exhibited.

In the case where an intersecting recess is formed so as to be continuous in the vertical direction, the second coating corresponding to that intersecting recess is also continuous in the vertical direction. On the other hand, in the case where an intersecting recess is formed so as to be discontinuous in the vertical direction, the second coating corresponding to that intersecting recess is also discontinuous in the vertical direction, and thus presence and feel similar to those of lumber that has been manually processed can be advantageously expressed.

Hereinafter, specific examples of the building board and the method for manufacturing the building board of the present embodiment will be described using FIGS. 1A to 4. In FIGS. 1A to 4, the longitudinal direction of building boards 1 to 4 is referred to as “left-right direction” (first direction), and a direction that is orthogonal to the longitudinal direction is referred to as “vertical direction” (second direction).

FIG. 1A is a front view of the building board 1 according to a first example. FIG. 1B is an enlarged view of a portion 1B in FIG. 1A, where the color of a first-coating portion having a high lightness has been made whitish with image processing, and the color of a second-coating portion having a low lightness has been made blackish with image processing. In other words, in FIG. 1B, the higher the height of a portion in the patterned region, the more the first coating, which has a high lightness, remains in that portion and the more whitish the color of that portion tends to be, whereas the lower the height of a portion in the patterned region, the more the second coating, which has a low lightness, remains in that portion and the more blackish the color of that portion tends to be.

The building board 1 shown in FIGS. 1A and 1B uses a wood fiber reinforced cement board as the base material board. A plurality of first joint-like grooves 31 extending in the left-right direction and a plurality of second joint-like grooves 32 extending vertically are provided on the surface of the base material board. Thus, the base material board is partitioned by the first joint-like grooves 31 and thus has an appearance of elongated boards joined to one another in the vertical direction, and due to being partitioned by the second joint-like grooves 32 also has an appearance of elongated boards joined to one another in the left-right direction. The elongated board-shaped regions individually constitute patterned regions. In each of the patterned regions demarcated by the first joint-like grooves 31 and the second joint-like grooves 32, wood grain such as growth rings and cracks are expressed by an uneven shape on the surface of the building board 1. Protrusions of this uneven shape constitute wood grain forming protrusions 11, and recesses constitute wood grain forming recesses. In FIG. 1B, the wood grain forming protrusions 11 are portions higher than the other portions in each patterned region and are thus shown as whitish portions 110. Moreover, as in the case of intersecting recesses 21 and 22, which will be described later, the wood grain forming recesses are portions lower than the other portions in each patterned region and are thus shown as blackish portions 112. Both of the wood grain forming protrusions 11 and the wood grain forming recesses extend in the left-right direction.

It should be noted that the first joint-like grooves 31 and the second joint-like grooves 32 are usually formed such that the depth of these joint-like grooves is deeper than the depth of the wood grain forming recesses of the uneven shape formed in each of the patterned regions demarcated by these joint-like grooves 31 and 32 and deeper than the depth of the intersecting recesses 21 and 22, which will be described later. At least the depth of the first joint-like grooves 31 is deeper than the depth of the wood grain forming recesses and the intersecting recesses 21 and 22.

In the building board 1 shown in FIG. 1A, the continuous intersecting recesses 21 and the discontinuous intersecting recesses 22 extend in the vertical direction in such a manner as to divide a wood grain pattern, that is, the wood grain forming protrusions 11. The continuous intersecting recesses 21 each have a strip shape, whose left end portion is continuous having a straight line shape and whose right end portion is full of ups and downs due to the shape of the end portions of the wood grain forming protrusions 11. That is to say, the right end portions of the individual continuous intersecting recesses 21 have a jagged shape that looks as if they were severed with a saw, instead of a straight line shape. The discontinuous intersecting recesses 22 each have a strip shape and intermittently extend in the vertical direction. Both of the left and right ends of the individual discontinuous intersecting recesses 22 are full of ups and downs due to the shape of the end portions of the wood grain forming protrusions 11 and have a jagged shape that looks as if they were severed with a saw. In FIG. 1B, the continuous intersecting recesses 21 and the discontinuous intersecting recesses 22 are portions lower than the other portions in each of the patterned regions, and are therefore shown as blackish portions.

A method for manufacturing the coatings formed on the wood grain forming protrusions 11, the continuous intersecting recesses 21, and the discontinuous intersecting recesses 22 will be described in detail below.

The building board 1 is manufactured using the above-described first manufacturing method. That is to say, while the base material board is conveyed in the left-right direction, the first-paint application step, the second-paint application step, and the second-paint wiping-off step are performed in this order. The left-right direction refers to a direction in which the wood grain forming protrusions 11 extend.

In the first-paint application step, a light brown acrylic silicon paint serving as the first paint is applied to the entire surface of the base material board at an amount of 7 g/shaku² (1 shaku=303.03 mm) by spraying, and then the base material board is dried using a drier at 100 to 115° C.

Subsequently, in the second-paint application step, a dark brown acrylic silicon paint serving as the second paint and having a lower lightness than the first paint is applied to the entire surface of the base material board, to which the first paint has been applied, at an amount of 7 g/shaku² by spraying.

Then, in the second-paint wiping-off step, before the second paint cures, the second paint is wiped off by bringing a rubber roll into contact with the surface of the base material board, the rubber roll being arranged perpendicular to the direction (conveyance direction) in which the base material board advances, and rotating the rubber roll in the same direction as the direction in which the base material board advances. Thereafter, the base material board is dried using a drier at 85 to 100° C. Thus, a second coating that has been partially wiped off is formed.

As shown in FIG. 1A, in the thus obtained building board 1, a light brown first coating is exposed on the wood grain forming protrusions 11, and the dark brown second coating is exposed on the continuous intersecting recesses 21 and the discontinuous intersecting recesses 22. More specifically, since the wood grain forming protrusions 11 are higher than the other portions, the second paint that has been applied to the wood grain forming protrusions 11 is wiped off by the rubber roll, and thus the first coating having a high lightness is exposed on the wood grain forming protrusions 11. Since the wood grain forming protrusions 11 extend in the left-right direction, the exposed first coating also is continuous in the left-right direction. In FIG. 1B, the wood grain forming protrusions 11 are whitish as shown in the portion denoted by reference numeral 110. On the other hand, since the continuous intersecting recesses 21 and the discontinuous intersecting recesses 22 are recessed, many portions thereof are not wiped by the rubber roll. Thus, the second paint remains on the continuous intersecting recesses 21 and the discontinuous intersecting recesses 22, and the second coating having a lower lightness is exposed on the continuous intersecting recesses 21 and the discontinuous intersecting recesses 22. In FIG. 1B, the continuous intersecting recesses 21 and the discontinuous intersecting recesses 22 are blackish.

The continuous intersecting recesses 21 continuously extend in the vertical direction, and the left end portions thereof have a straight line shape, while the right end portions thereof have a jagged shape with closely spaced notches. Thus, the second coating formed on each of the continuous intersecting recesses 21 also continuously extends in the vertical direction, the left end portion thereof has a straight line shape, and the right end portion thereof has a jagged shape with closely spaced notches.

The discontinuous intersecting recesses 22 each intermittently extend in the vertical direction, and both of the left and right end portions thereof have a jagged shape with closely spaced notches. Thus, the second coating formed on each of the discontinuous intersecting recesses 22 also intermittently extends in the vertical direction, and the left and right end portions thereof have a jagged shape with closely spaced notches.

It should be noted that the first joint-like grooves 31, the second joint-like grooves 32, and the wood grain forming recesses are also recessed, and many portions thereof are not wiped by the rubber roll. Thus, the second paint remains thereon, and the second coating having a low lightness is exposed thereon. In FIG. 1B, bottom portions of the first joint-like grooves 31 and the second joint-like grooves 32 are blackish.

As described above, in the building board 1, the wood grain forming protrusions 11 are formed in each of the regions demarcated by the first joint-like grooves 31 and the second joint-like grooves 32. Thus, the building board 1 has an appearance of a plurality of wood boards joined to one another. Moreover, the continuous intersecting recesses 21 and the discontinuous intersecting recesses 22, the intersecting recesses each having a strip shape, are formed extending in the vertical direction in some of the regions, and the second coating having a lower lightness than the first coating formed on the wood grain forming protrusions 11 is formed on each of the intersecting recesses 21 and 22. Thus, accented with the intersecting recesses 21 and 22, the shape of the first coating (shape of the wood grain forming protrusions 11) becomes more prominent, and a three-dimensional, wood-grain-textured appearance can be expressed.

Moreover, the end portions of the continuous intersecting recesses 21 and the discontinuous intersecting recesses 22 each have a shape that looks as if they were severed with a saw. Thus, feel and presence similar to those obtained by processing manually using a saw or the like can be expressed.

Furthermore, since the continuous intersecting recesses 21 whose end portions have a straight line shape are formed, end portions of the wood grain forming protrusions 11 that are adjacent to those straight line-shaped end portions become even more prominent, and thus an even more three-dimensional appearance can be expressed.

It should be noted that although FIGS. 1A and 1B show the building board 1 in which the continuous intersecting recesses 21 and the discontinuous intersecting recesses 22 are provided in only some of the regions, the present invention is not limited to this, and the continuous intersecting recesses 21 and the discontinuous intersecting recesses 22 may be provided in all of the wood grain patterned regions in which the wood grain forming protrusions 11 are formed.

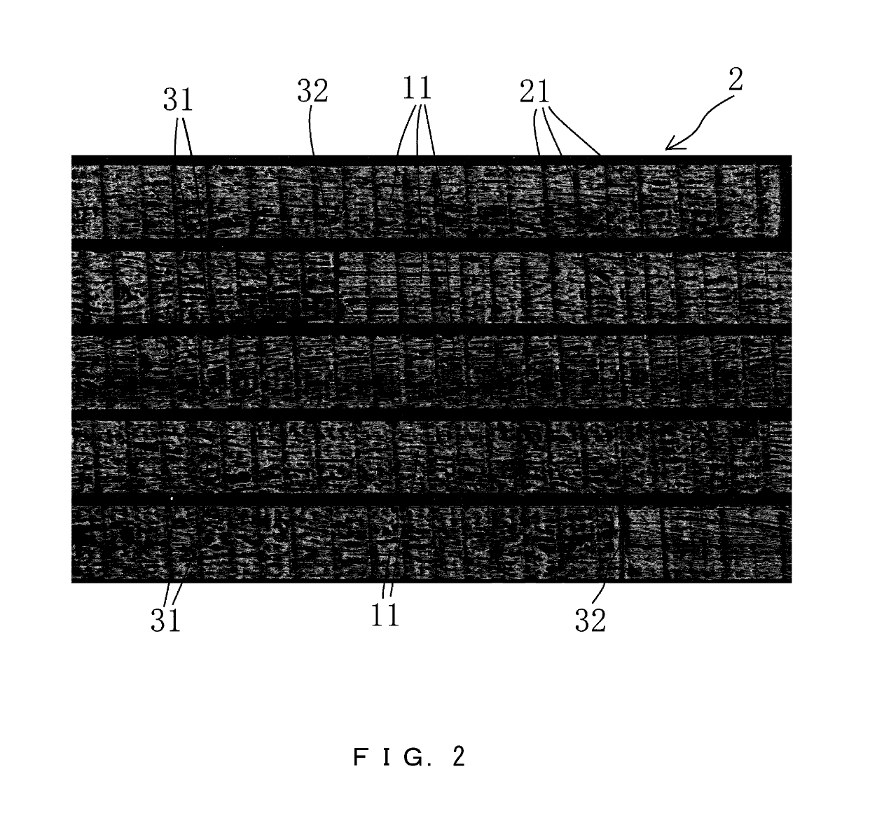

FIG. 2 is a front view of another building board 2 according to the present embodiment. In the building board 2, continuous intersecting recesses 21 are provided in all of the regions in which wood grain forming protrusions 11 are formed. In the building board 2 as well, similar to the building board 1, the continuous intersecting recesses 21 make the shape of the first coating (shape of the wood grain forming protrusions 11) more prominent, and thus a three-dimensional, wood-grain-textured appearance can be expressed.

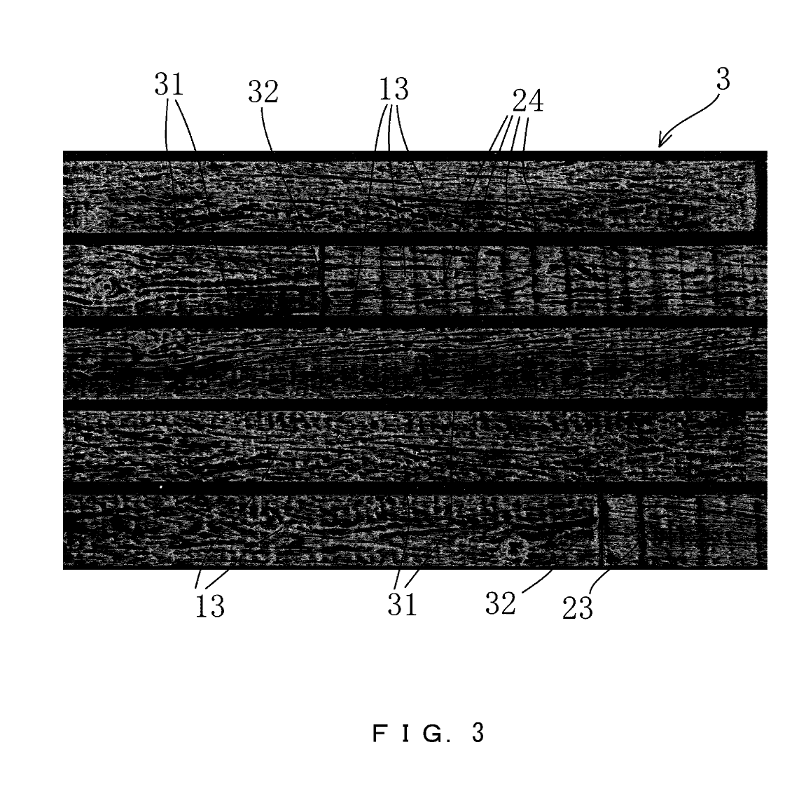

FIG. 3 is a front view of still another building board 3 according to the present embodiment.

The building board 3 shown in FIG. 3 also uses a wood fiber reinforced cement board as the base material board. The surface of the base material board is partitioned into a plurality of regions in the vertical direction by the first joint-like grooves 31 and also is partitioned into a plurality of regions in the left-right direction by the second joint-like grooves 32. Moreover, an uneven shape expressing growth rings, cracks, and the like of a wood grain is formed on the surface in each of the partitioned regions, and protrusions and recesses of that uneven shape constitute wood grain forming protrusions 13 and wood grain forming recesses, respectively. Both of the wood grain forming protrusions 13 and the wood grain forming recesses extend in the left-right direction.

In the building board 3 shown in FIG. 3, continuous intersecting recesses 23 and discontinuous intersecting recesses 24 extend in the vertical direction in such a manner as to divide the wood grain forming protrusions 13. The continuous intersecting recesses 23 each have a strip shape and extend continuously in the vertical direction. Both of left and right ends of the individual continuous intersecting recesses 23 do not have a straight line shape, but instead, are full of ups and downs due to the shape of the end portions of the wood grain forming protrusions 13 and thus have a jagged shape that looks as if they were severed with a saw. The discontinuous intersecting recesses 24 each have a strip shape and extend intermittently in the vertical direction. Both of left and right ends of the individual discontinuous intersecting recesses 24 are full of ups and downs due to the shape of the end portions of the wood grain forming protrusions 13 and thus have a jagged shape that looks as if they were severed with a saw.

Coatings formed on the wood grain forming protrusions 13, the continuous intersecting recesses 23, and the discontinuous intersecting recesses 24 will be described in detail below while describing a manufacturing method.

The building board 3 is manufactured using the above-described second manufacturing method. That is to say, the building board 3 is manufactured by performing the second-paint application step and the first-paint application step in this order while conveying the base material board in the left-right direction. The left-right direction refers to a direction in which the wood grain forming protrusions 13 extend. A dark brown acrylic silicon paint serving as the second paint and having a lower lightness than the first paint is applied to the entire surface of the base material board at an amount of 7 g/shaku² by spraying, and then the base material board is dried using a drier at 85 to 100° C. Subsequently, while the base material board on which the second coating has been formed is conveyed in the left-right direction, a light brown acrylic silicon paint having a high lightness is applied to the wood grain forming protrusions 13 at an amount of 7 g/shaku² by pressing a coating roll against the wood grain forming protrusions 13, the coating roll being arranged perpendicular to the direction (conveyance direction) in which the base material board advances, and then the base material board is dried using a drier at 0 to 115° C. to form a first coating.

In the thus obtained building board 3, as shown in FIG. 3, the light brown first coating is exposed on the wood grain forming protrusions 13, and the dark brown second coating is exposed on the continuous intersecting recesses 23 and the discontinuous intersecting recesses 24. More specifically, since the wood grain forming protrusions 13 are higher than the other portions, the wood grain forming protrusions 13 come into contact with the coating roll, and consequently, the first paint on the coating roll is transferred onto the wood grain forming protrusions 13. Thus, the first coating is exposed on the wood grain forming protrusions 13. Since the wood grain forming protrusions 13 extend in the left-right direction, the exposed first coating is also continuous in the left-right direction. On the other hand, since the continuous intersecting recesses 23 and the discontinuous intersecting recesses 24 are recessed, many portions thereof do not come into contact with the coating roll. Thus, the second paint remains on the continuous intersecting recesses 23 and the discontinuous intersecting recesses 24, and the second coating is exposed on the continuous intersecting recesses 23 and the discontinuous intersecting recesses 24. The continuous intersecting recesses 23 each extend continuously in the vertical direction, and both of the left and right end portions of the individual continuous intersecting recesses 23 have a jagged shape. Accordingly, the second coating formed on each of the continuous intersecting recesses 23 also extend continuously in the vertical direction, and both of the left and right end portions thereof have a jagged shape. The discontinuous intersecting recesses 24 each extend intermittently in the vertical direction, and both of the left and right ends of the individual discontinuous intersecting recesses 24 have a jagged shape. Accordingly, the second coating formed on each of the discontinuous intersecting recesses 24 also extends intermittently in the vertical direction, and both of the left and right end portions thereof have a jagged shape.

It should be noted that since the first joint-like grooves 31, the second joint-like grooves 32, and the wood grain forming recesses are also recessed, and many portions thereof do not come into contact with the coating roll, the second coating having a low lightness is exposed thereon.

As described above, in the building board 3, the wood grain forming protrusions 13 are formed in the regions demarcated by the first joint-like grooves 31 and the second joint-like grooves 32, and thus the building board 3 has an appearance of a plurality of wood boards joined to one another. Moreover, in some of the regions, the continuous intersecting recesses 23 and the discontinuous intersecting recesses 24, the intersecting recesses each having a strip shape, are formed in the vertical direction. The second coating having a lower lightness than the first coating formed on the wood grain forming protrusions 13 is formed on the continuous intersecting recesses 23 and the discontinuous intersecting recesses 24. Thus, accented with the continuous intersecting recesses 23 and the discontinuous intersecting recesses 24, the shape of the first coating (shape of wood grain forming protrusions 13) becomes more prominent, and a three-dimensional, wood-grain-textured appearance can be expressed. In addition, the end portions of the continuous intersecting recesses 23 and the discontinuous intersecting recesses 24 each have a shape that looks as if they were severed with a saw, and thus a feel similar to that obtained by processing manually using a saw or the like can be expressed.

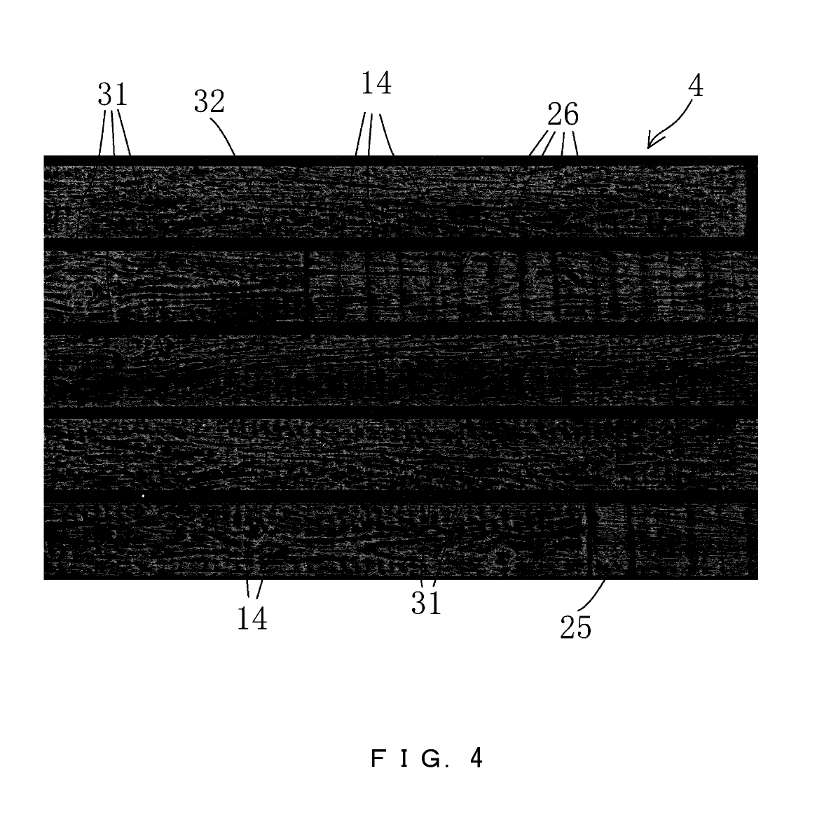

FIG. 4 is a front view of still another building board 4 according to the present embodiment.

The building board 4 shown in FIG. 4 uses a metal board as the base material board. The surface of the base material board is partitioned in the vertical direction by the first joint-like grooves 31 and is also partitioned in the left-right direction by the second joint-like grooves 32. An uneven shape expressing growth rings, cracks, and the like of a wood grain is formed on the surface in each of the partitioned regions, and protrusions and recesses of the uneven shape constitute wood grain forming protrusions 14 and wood grain forming recesses, respectively. Both of the wood grain forming protrusions 14 and the wood grain forming recesses extend in the left-right direction.

In the building board 4, continuous intersecting recesses 25 and discontinuous intersecting recesses 26 extend in the vertical direction in such a manner as to divide the wood grain forming protrusions 14. The continuous intersecting recesses 25 each have a strip shape and extend continuously in the vertical direction. Both of left and right ends of the individual continuous intersecting recesses 25 do not have a straight line shape, but instead, are full of ups and downs due to the shape of end portions of the wood grain forming protrusions 14 and thus have a jagged shape that looks as if they were severed with a saw. The discontinuous intersecting recesses 26 each have a strip shape and extend intermittently in the vertical direction. Both of left and right ends of the individual discontinuous intersecting recesses 26 are full of ups and downs due to the shape of the end portions of the wood grain forming protrusions 14 and thus have a jagged shape that looks as if they were severed with a saw.

The building board 4 is coated using the second manufacturing method, which is the same as in the case of the above-described building board 3. That is to say, while the base material board is conveyed in the left-right direction, a dark brown acrylic silicon paint serving as the second paint and having a lower lightness than the first paint is applied to the entire surface of the base material board at an amount of 7 g/shaku² by spraying, and drying is performed using a drier at 85 to 100° C. Subsequently, while the base material board on which the second coating has been formed is conveyed in the left-right direction, a light brown acrylic silicon paint having a high lightness is applied to the wood grain forming protrusions 14 at an amount of 7 g/shaku² by pressing a coating roll against the wood grain forming protrusions 14, the coating roll being arranged perpendicular to the direction (conveyance direction) in which the base material board advances, and drying is performed using a drier at 100 to 115° C. to form the first coating.

Consequently, in the thus obtained building board 4, as shown in FIG. 4, the light brown first coating having a high lightness is exposed on the wood grain forming protrusions 14, and the dark brown second coating having a low lightness is exposed on the continuous intersecting recesses 25 and the discontinuous intersecting recesses 26. The continuous intersecting recesses 25 each continuously extend in the vertical direction, and both of the left and right end portions thereof have a jagged shape. Thus, the second coating formed on each of the continuous intersecting recesses 25 also extends continuously in the vertical direction, and both of left and right end portions thereof have a jagged shape. The discontinuous intersecting recesses 26 each extend intermittently in the vertical direction, and both of the left and right end portions thereof have a jagged shape. Thus, the second coating formed on each of the discontinuous intersecting recesses 26 also extend intermittently in the vertical direction, and both of left and right end portions thereof have a jagged shape.

In addition, the first joint-like grooves 31, the second joint-like grooves 32, and the wood grain forming recesses 14 are also recessed, and many portions thereof do not come into contact with the coating roll. Thus, the second coating having a low lightness is exposed thereon.

As described above, in the building board 4, the wood grain forming protrusions 14 are formed in the regions demarcated by the first joint-like grooves 31 and the second joint-like grooves 32, and thus the building board 4 has an appearance of a plurality of wood boards joined to one another. Moreover, in some of the regions, the continuous intersecting recesses 25 and the discontinuous intersecting recesses 26, the intersecting recesses each having a strip shape, are formed in the vertical direction. The second coating having a lower lightness than the first coating formed on the wood grain forming protrusions 14 is formed on the continuous intersecting recesses 25 and the discontinuous intersecting recesses 26. Thus, accented with the continuous intersecting recesses 25 and the discontinuous intersecting recesses 26, the shape of the first coating (shape of the wood grain forming protrusions 14) becomes more prominent, and a three-dimensional, wood-grain-textured appearance can be expressed. In addition, the end portions of the continuous intersecting recesses 25 and the discontinuous intersecting recesses 26 each have a shape that looks as if they were severed with a saw. Thus, a feel similar to that obtained by processing manually using a saw or the like can be expressed.

Although an embodiment of the present invention has been described above, the present invention is not limited to the foregoing embodiment and can be implemented in various modified forms that fall within the scope of the invention as set forth in the appended claims.

What is claimed is:

1. A building board comprising:
a base material board;
a patterned region formed on the base material board and demarcated by a first joint-like groove and a second joint-like groove intersecting the first joint-like groove;
a plurality of wood grain forming protrusions formed in the patterned region so as to express a wood grain pattern;
an intersecting recess formed in the patterned region to have a strip shape extending in a direction intersecting the wood grain pattern;
a first coating formed on the wood grain forming protrusions; and
a second coating formed on the intersecting recess, the second coating having a lower lightness than the first coating.

2. The building board according to claim 1,
wherein at least one of lateral side portions of the strip shape of the intersecting recess has a serrated shape, and
the second coating has a serrated shape in conformity with the lateral side portion having the serrated shape, of the intersecting recess.

3. The building board according to claim 1,
wherein at least one of lateral side portions of the strip shape of the intersecting recess has a substantially straight line shape, and
the second coating has a substantially straight line shape in conformity with the lateral side portion having the substantially straight line shape, of the intersecting recess.

4. The building board according to claim 1,
wherein one of lateral side portions of the strip shape of the intersecting recess has a serrated shape,
the other lateral side portion of the strip shape of the intersecting recess has a substantially straight line shape, and
the second coating has a serrated shape and a substantially straight line shape in conformity with the respective lateral side portions having the serrated shape and the substantially straight line shape, of the intersecting recess.

5. The building board according to claim 1,
wherein the strip shape of the intersecting recess is discontinuous.

6. The building board according to claim 1,
wherein the strip shape of the intersecting recess is discontinuous,
at least one of lateral side portions of the strip shape of the intersecting recess has a serrated shape, and
the second coating has a serrated shape in conformity with the lateral side portion having the serrated shape, of the intersecting recess.

7. The building board according to claim 1,
wherein the strip shape of the intersecting recess is continuous,
at least one of lateral side portions of the strip shape of the intersecting recess has a serrated shape, and
the second coating has a serrated shape in conformity with the lateral side portion having the serrated shape, of the intersecting recess.

8. The building board according to claim 1,
wherein the intersecting recess has a shallower depth than the wood grain pattern, and
at least one of the first joint-like groove and the second joint-like groove has a deeper depth than the intersecting recess.

9. A method for manufacturing a building board, the method comprising the steps of:
preparing a base material board having a patterned region demarcated by a first joint-like groove and a second joint-like groove intersecting the first joint-like groove on a surface of the base material board, a plurality of wood grain forming protrusions and an intersecting recess formed in the patterned region, the wood grain forming protrusions formed to express a wood grain pattern, and the intersecting recess having a strip shape extending in a direction that intersects the wood grain pattern;
forming a first coating on the surface of the base material board by applying a first paint to the surface of the base material board and drying the first paint;
applying a second paint having a lower lightness than the first paint to the surface of the base material board on which the first coating is formed; and
wiping off a portion of the second paint before the second paint cures so as to expose the first coating on the wood grain forming protrusions while exposing a second coating composed of the second paint on the intersecting recess.

10. The method for manufacturing a building board according to claim 9,
wherein one of lateral side portions of the strip shape of the intersecting recess has a serrated shape,
the other lateral side portion of the strip shape of the intersecting recess has a substantially straight line shape, and
the second coating has a serrated shape and a substantially straight line shape in conformity with the respective lateral side portions having the serrated shape and the substantially straight line shape, of the intersecting recess.

11. The method for manufacturing a building board according to claim 9,
wherein the strip shape of the intersecting recess is discontinuous,
at least one of lateral side portions of the strip shape of the intersecting recess has a serrated shape, and
the second coating has a serrated shape in conformity with the lateral side portion having the serrated shape, of the intersecting recess.

12. The method for manufacturing a building board according to claim 9,
wherein the strip shape of the intersecting recess is continuous,
at least one of lateral side portions of the strip shape of the intersecting recess has a serrated shape, and
the second coating has a serrated shape in conformity with the lateral side portion having the serrated shape, of the intersecting recess.

13. The method for manufacturing a building board according to claim 9,
wherein the intersecting recess has a shallower depth than the wood grain pattern, and
at least one of the first joint-like groove and the second joint-like groove has a deeper depth than the intersecting recess.

14. A method for manufacturing a building board, the method comprising the steps of:
preparing a base material board having a patterned region demarcated by a first joint-like groove and a second joint-like groove intersecting the first joint-like groove on a surface of the base material board, a plurality of wood grain forming protrusions and an intersecting recess formed in the patterned region, the wood grain forming protrusions formed to express a wood grain pattern, and the intersecting recess having a strip shape extending in a direction that intersects the wood grain pattern;
forming a second coating on the surface of the base material board by applying a second paint to the surface of the base material board and drying the second paint; and
applying a first paint having a higher lightness than the second paint to a surface of the wood grain forming protrusions by pressing a coating roll against the surface of the base material board, and drying the first paint so as to form a first coating on the surface of the wood grain forming protrusions in a state in which the second coating is exposed on the intersecting recess.

15. The method for manufacturing a building board according to claim 14,
wherein one of lateral side portions of the strip shape of the intersecting recess has a serrated shape,
the other lateral side portion of the strip shape of the intersecting recess has a substantially straight line shape, and
the second coating has a serrated shape and a substantially straight line shape in conformity with the respective lateral side portions having the serrated shape and the straight line shape, of the intersecting recess.

16. The method for manufacturing a building board according to claim 14,
wherein the strip shape of the intersecting recess is discontinuous,
at least one of lateral side portions of the strip shape of the intersecting recess has a serrated shape, and
the second coating has a serrated shape in conformity with the lateral side portion having the serrated shape, of the intersecting recess.

17. The method for manufacturing a building board according to claim 14,
wherein the strip shape of the intersecting recess is continuous,
at least one of lateral side portions of the strip shape of the intersecting recess has a serrated shape, and
the second coating has a serrated shape in conformity with the lateral side portion having the serrated shape, of the intersecting recess.

18. The method for manufacturing a building board according to claim 14,
wherein the intersecting recess has a shallower depth than the wood grain pattern, and
at least one of the first joint-like groove and the second joint-like groove has a deeper depth than the intersecting recess.
